(19) United States
(12) Patent Application Publication
(10) Pub. No.: US 2024/0103234 A1
(43) Pub. Date: Mar. 28, 2024

(54) FERRULE OF OPTICAL CABLE WITH MULTI CORES

(71) Applicants: CHIH-CHENG CHIEN, New Taipei City (TW); TSO-HAN CHIEN, New Taipei City (TW)

(72) Inventors: CHIH-CHENG CHIEN, New Taipei City (TW); TSO-HAN CHIEN, New Taipei City (TW)

(21) Appl. No.: 18/336,061

(22) Filed: Jun. 16, 2023

(30) Foreign Application Priority Data
Sep. 26, 2022 (TW) 111136357

(51) Int. Cl. G02B 6/38

(52) U.S. Cl. CPC G02B 6/3885; G02B 6/3825; G02B 6/3897

(57) ABSTRACT

A ferrule of optical cable with multi cores includes a casing and at least one main body. The main body is connected to the casing. A plurality of main body through-holes are formed on the at least one main body. The casing and the main body are separately formed and fixed to each other. A plurality of optical fibers of a fiber optical cable pass through the main body through-holes and extrude out of the casing.

### CROSS-REFERENCE TO RELATED APPLICATION

This non-provisional application claims priority under 35 U.S.C. § 119(a) on Patent Application No(s). 111136357 filed in Taiwan, R.O.C. on Sep. 26, 2022, the entire contents of which are hereby incorporated by reference.

### BACKGROUND OF THE INVENTION

### 1. Field of the Invention

The present disclosure relates to a ferrule of optical cable with multi cores, and in particular to a ferrule capable of avoiding axial offset which results in signal loss when fiber optic connectors are connected.

### 2. Description of the Related Art

Fiber optical cable is a widely used optical communication cable for high-speed signal transmission. Generally, a fiber optical cable consists of optical fibers and a protective layer. The optical fibers are enclosed within the protective layer, and optical signals inputted from one end of the fiber can be transmitted through the fibers to the other end. Throughout the transmission process, fiber optical cables have minimal loss compared to traditional copper cables, making them frequently used as a medium for long-distance signal transmission.

Conventional fiber optical cables used in the market can be broadly classified into two categories: single core optical fiber and optical cable with multi cores. Taking multi cores fiber as an example, each cable contains multiple optic al fibers. When two different multi cores fibers are connected to each other using fiber optic connectors, axial offset, angular misalignment of the cross-section, and axial plane spacing between the fibers will cause signal loss in terms of signal intensity. Among these factors, axial offset has the most significant impact.

Besides, when connecting different optical fibers, it is common to use ferrules with multiple through-holes to secure the fibers, with a portion of the fiber exposed outside the ferrule. However, in the case of mechanical transfer (MT) ferrules formed through methods like injection molding and subsequently cooled, the originally predetermined dimensions of the through-holes can easily experience changes in aperture or positional displacement due to thermal shrinkage of the material. For optical fibers that require extremely high precision, such phenomena can result in axial offset during the connection process, leading to signal intensity loss.

### BRIEF SUMMARY OF THE INVENTION

Aspects and advantages of embodiments of the present disclosure will be set forth in part in the following description, or may be learned from the description, or may be learned through practice of the embodiments.

An example aspect of the present disclosure is directed to a ferrule of optical cable with multi cores. The ferrule includes a casing and at least one main body. The main body is connected to the casing. A plurality of main body through-holes are formed on the at least one main body. The casing and the main body are separately formed and fixed to each other. A plurality of optical fibers of a fiber optical cable pass through the main body through-holes and extrude out of the casing.

In some implementations, the casing is formed with a plurality of casing through-holes aligned with the plurality of main body through-holes.

In some implementations, the casing includes a plurality of side walls connected to each other. A cavity is surrounded by the side walls. The casing through-holes are formed on a first side wall of the side walls. An opening is formed on a second side wall of the side walls. The main body is disposed into the cavity through the opening and abuts against the first side wall.

In some implementations, the casing includes a plurality of side walls connected to each other. A cavity is surrounded by the side walls. The casing through-holes are formed on a first side wall of the side walls. The main body is disposed outside the cavity and fixed to the first side wall.

In some implementations, the casing includes a rear end portion and a front end portion. The rear end portion is formed with a passage, and the fiber optical cable passes through the passage. The front end portion is connected to the rear end portion and formed with an accommodating slot. A profile and dimensions of the accommodating slot are substantially equal to the main body. The passage communicates with the accommodating slot. The main body is disposed in the accommodating slot and abuts against the rear end portion.

In some implementations, the casing is formed with a passage. The main body is fixed to an end of the casing. The main body through-holes communicate with the passage.

In some implementations, the ferrule further includes a sheath movably disposed relative to the casing, and the fiber optical cable passes through the sheath.

In some implementations, the casing is formed with at least one casing guiding hole, the main body is formed with at least one main body guiding hole aligned with the casing guiding hole.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a perspective view illustrating a ferrule of optical cable with multi cores applied to a fiber optical cable according to some exemplary embodiments.

FIG. 2 is an exploded view illustrating the ferrule in FIG. 1.

FIG. 3 is a rear view illustrating the main body in FIG. 2.

FIG. 4 is a rear view illustrating the casing in FIG. 2.

FIG. 5 is a cross-sectional view illustrating the ferrule in FIG. 1.

FIG. 6 is a rear view illustrating the sheath in FIG. 2.

FIG. 7 is a top view illustrating a ferrule of optical cable with multi cores applied to a fiber optical cable according to some exemplary embodiments.

FIG. 8 is an exploded view illustrating the ferrule in FIG. 7.

FIG. 9 is a rear view illustrating the ferrule in FIG. 7.

FIG. 10 is a cross-sectional view illustrating the ferrule in FIG. 7.

FIG. 11 is another perspective view illustrating a ferrule of optical cable with multi cores applied to a fiber optical cable according to some exemplary embodiments.

### DETAILED DESCRIPTION OF THE INVENTION

The aforementioned and other technical features, characteristics and effects of the present disclosure may be clearly presented by the detailed description of exemplary embodiments together with the attached figures. In addition, in the following embodiments, the same or similar components will use the same or similar reference numerals.

In addition, the components, methods, processes and steps disclosed by the embodiments are only illustrative and not intended to limit. Therefore, a person skilled in the art can appropriately increase, omit, modify or execute each component, method, process or step alone without deviating from the spirit and the scope of the invention, unless the change results in timing or technical inconsistencies. Besides, the orders of each method, process or step can also be altered or adjusted.

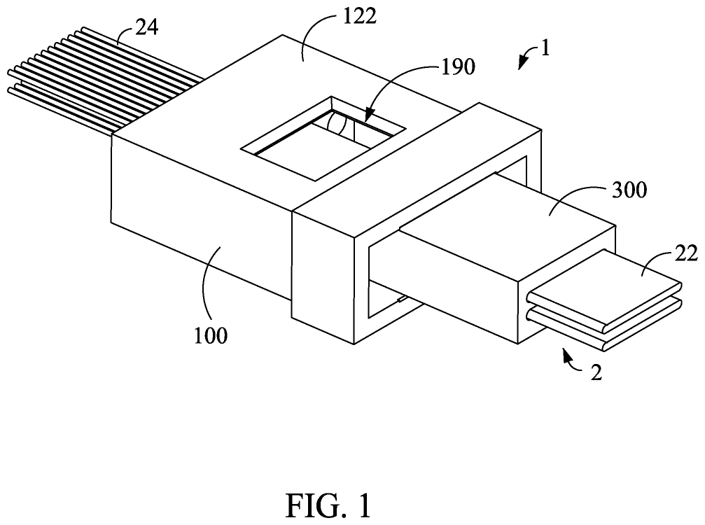

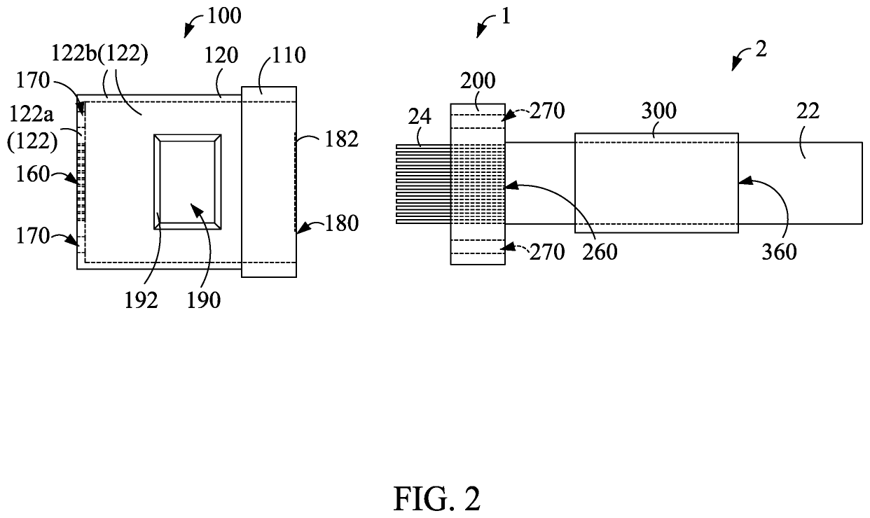

Refer to FIG. 1 and FIG. 2. The ferrule 1 in the embodiment is adapted for a fiber optical cable 2. The fiber optical cable 2 may be an optical cable with multi cores having at least one covering layer 22 and a plurality of optical fibers 24, and the optical fibers 24 is enclosed in the covering layer 22. Specifically, the fiber optical cable 2 may be a twelve by two optical cable with multi cores. That is, the fiber optical cable 2 has two covering layers 22 stacking with each other. Each covering layer 22 contains twelve optical fibers 24 therein, but the respective numbers of the covering layers 22 and optical fibers 24 are not limited by the present invention. On the other hand, the ferrule 1 includes a casing 100 and at least one main body 200. The main body 200 is connected to the casing 100 and formed with a plurality of main body through-holes 260. The optical fibers 24 pass through the main body through-holes 260 and extrude out of the casing 100. Moreover, the number of the main body 200 in the current figures is one. However, it is not limited thereto, which means the main body 200 may be plural.

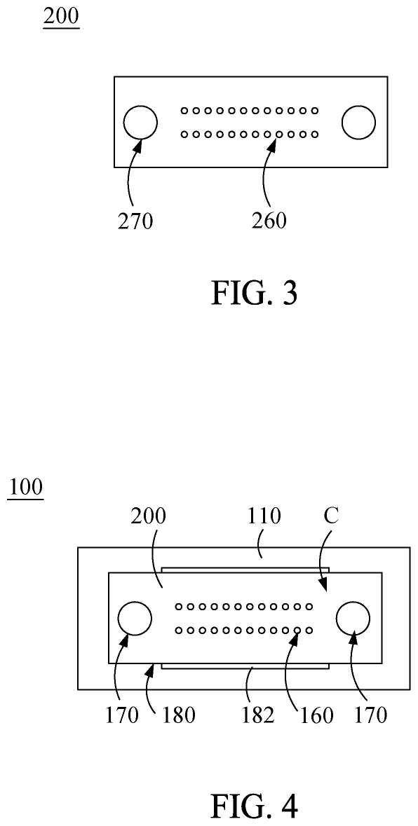

Please also refer to FIG. 3. In the embodiment, the main body 200 is exemplary to be a rectangular solid made of resin, and the main body through-holes 260 are formed on the rectangular cross-sections and penetrate the main body 200 in the front and rear direction. Thereby, when user would like to connect fiber optical cables, the covering layer 22 can be removed through a specific wire stripper, and each optical fiber 24 may be disposed to pass through corresponding main body through-holes 260, so as to hold the fiber optical cable 2 and expose the optical fibers 24. In some embodiments, the main body 200 may also be cubic, elliptical cylindrical or other geometrical shapes, and the material thereof may be chosen from other feasible materials. It is not limited by the present invention.

Pleas also refer to FIG. 4. In the embodiment, the casing 100 includes a rear end portion 110 and a front end portion 120. The front end portion 120 is connected to the rear end portion 110 and includes a plurality of side walls 122. The side walls 122 is connected to each other and surrounds a cavity C. One of the side walls, which is referred to the first side wall 122a hereinafter, is formed with a plurality of casing through-holes 160 thereon. When the casing 100 and the main body 200 are formed separately. The main body 200 can be disposed in the cavity C and fixed by injection molding or glue potting. At the same time, the main body through-holes 260 are aligned with the casing through-holes 160 to make the optical fibers 24 pass through the main body through-holes 260 and casing through-holes 160 in sequence, and finally extrude out of the casing 100. In this implementation, both the casing 100 and the main body 200 can be made of the same material.

Specifically, so far, when two different optical fibers are needed to be connected, it is necessary to cut the fibers and thread them through ferrules with fiber through-holes to allow each fiber to be exposed. Then, the ferrules holding the fibers are installed onto connectors used for fiber connection, and the connection process is completed by aligning each fiber through the connectors. However, in the case of conventional mechanical transfer (MT) ferrules, they were typically manufactured through one-time injection molding to form the entire ferrule component. Therefore, when the high-temperature ferrule is cooled to room temperature, the fiber through-holes formed in the ferrule are prone to aperture changes or positional displacement due to thermal shrinkage. It could result in axial offset during fiber connection, affect alignment accuracy and cause signal intensity loss. Therefore, the casing 100 and the main body 200 of the ferrule 1 in this embodiment are separately formed and then combined. Compared to the integrally manufactured ferrule, the individually formed main body 200 has less material. Consequently, the aperture variation and through-hole displacement caused by thermal shrinkage of the main body through-holes 260 are significantly reduced during cooling, It, in turn, reduces the occurrence of axial offset of the optical fibers 24 when connecting the fiber optical cables 2. Experimental results have demonstrated that the ferrule 1 with separately formed and then combined components can increase the yield rate (considering optical cable with multi cores, where signal intensity loss exceeding 0.3 dB is deemed as defective) from 60% to over 90%, thereby significantly reducing signal loss in the fiber optical cable 2.

As shown in FIG. 1 and FIG. 2, another one of side walls 122, which is referred to the second side wall 122b hereinafter, is formed with an injecting opening 190, and the second side wall 122b may be disposed adjacent to the first side wall 122a. Once the main body 200 is disposed at a certain position in the cavity C, an adhesive, such as AB glue, for securing the main body 200 can be injected through the injecting opening 190 to fix the main body 200 relative to the casing 100. In some embodiments, a guiding portion 192 is further formed on the casing 100. The guiding portion 192 may be an incline and disposed adjacent to the injecting opening 190. Thereby, during the adhesive injection process, the adhesive can flow along the guiding portion 192 into the cavity C, without contaminating other areas of the casing 100 or causing unintended adhesion to other components.

As shown in FIG. 3 and FIG. 4, in some embodiments, the main body 200 may be further formed with at least one main body guiding hole 270. The main body guiding holes 270, for example, may be two and symmetrically disposed relative to the main body through-holes 260. On the other hand, the casing 100 may be further formed with at least one casing guiding hole 170. The size and shape of the casing guiding holes 170 correspond to the main body guiding holes 270. The casing guiding holes 170 in this embodiment may be two and symmetrically disposed relative to the casing through-holes 160. The main body guiding holes 270 and the casing guiding holes 170 are configured to align the ferrules belonging to two different connectors with each other. However, the actual quantity and specific positions of the main body guiding holes 270 and the casing guiding holes 170 are not limited by the present invention. When the main body 200 is disposed in the cavity C, a positioning pin (not shown) can be inserted through the casing guiding holes 170 and the main body guiding holes 270 to achieve the alignment mentioned above. The signal transmission quality of the fiber optical cable 2 is thus improved.

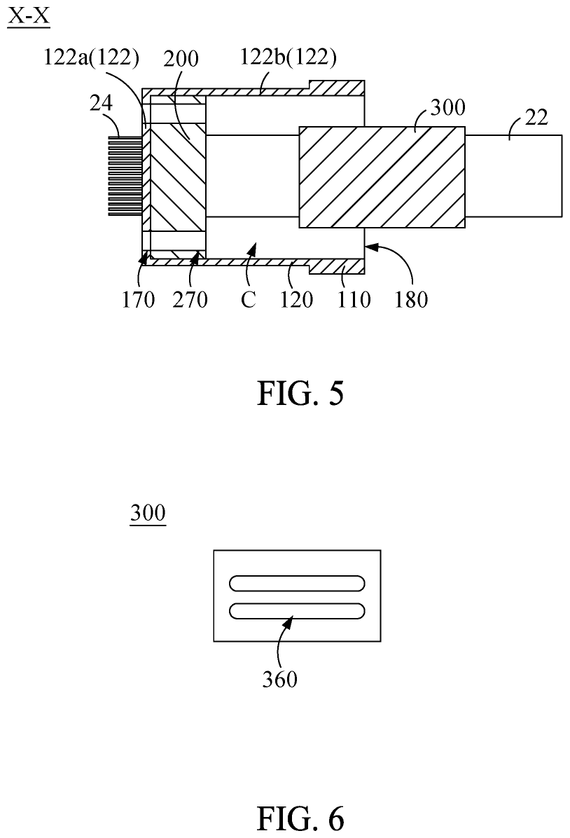

Refer to FIG. 5. As shown in FIG. 1 to FIG. 5, especially in FIGS. 2, 4 and 5, an opening 180 is formed on the rear end portion 110. The first side wall 122a is away from the opening 180, and the main body 200 abuts against the first side wall 122a. By the arrangement, the main body 200 can be disposed into the cavity C through the opening 180 and continuously pushed until it contacts the first side wall 122a. It ensures that the main body 200 is engaged in the casing 100, and they are combined together.

In some embodiments, a profile and dimensions of the opening 180 are substantially equal to the main body 200, and the inner wall of the casing 100 is flush with the opening 180. Preferably, the casing 100 may be further formed with a transition portion 182. The transition portion 182 may be a chamfered incline and adjacent to the opening 180. Thereby, the main body 200 can be easier inserted into the casing 100 through the opening 180 with the assistance of the transition portion 182, and a tight fit relationship between the main body 200 and the casing 100 is ensured throughout the process from passing through the opening 180 to contacting the first side wall 122a. It prevents any offset or rotation of the main body 200 during the assembly, thereby avoiding possible failure in the joining process.

Refer to FIG. 6. Specifically, in order to prevent the fiber optical cable 2 from being bent to affect the light transmission efficiency in the optical fibers 24, in some embodiments, the ferrule 1 may further include a sheath 300. The sheath 300 is movably disposed relative to the casing 100. Specifically, the sheath 300 may be a rectangular solid structure and formed with at least one penetrating hole 360. The number of the penetrating holes 360 correspond to the covering layers 22, but it is not limited thereto.

As shown in FIG. 5, the width or thickness of the sheath 300 in this embodiment is set to be smaller than the opening 180 and the cavity C. Therefore, when one end of the fiber optical cable 2 is fixed through the joining of the casing 100 and the main body 200, another end of the fiber optical cable 2 held by the sheath 300 has a certain degree of freedom in displacement. It helps prevent the fiber optical cable 2 from breaking due to excessive tension.

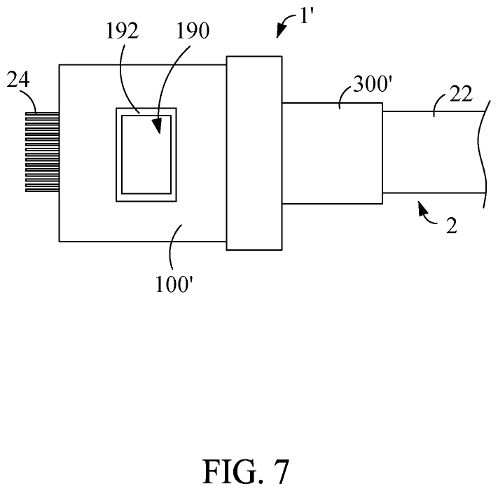

Refer to FIG. 7 to FIG. 10. The ferrule 1′ in the embodiment is essentially similar to the ferrule 1. The major difference between them is that the casing 100′ does not have casing through-holes 160, and the sheath 300′ can be selectively engaged to the casing 100′.

Specifically, the casing 100′ in this embodiment includes a rear end portion 110′ and a front end portion 120′. The rear end portion 110′ is formed with an opening 180′ and a passage P. The passage P extends in the anterior-posterior direction, and the height and width of the passage P are, for example, identical to the opening 180′, but it is not limited by the present invention. On the other hand, the front end portion 120′ is connected to the rear end portion 110′ and formed with an accommodating slot A. A profile and dimensions of the accommodating slot A are substantially equal to the main body 200, and the passage P communicates with the accommodating slot A. By the arrangements, after the casing 100′ and the main body 200 are separately formed, the main body 200 can be disposed into the accommodating slot A and joined to the casing 100′ through methods such as adhesive bonding or injection molding. This makes the main body 200 become a part of the casing 100′ and aligns it with the outer surfaces of the casing 100′.

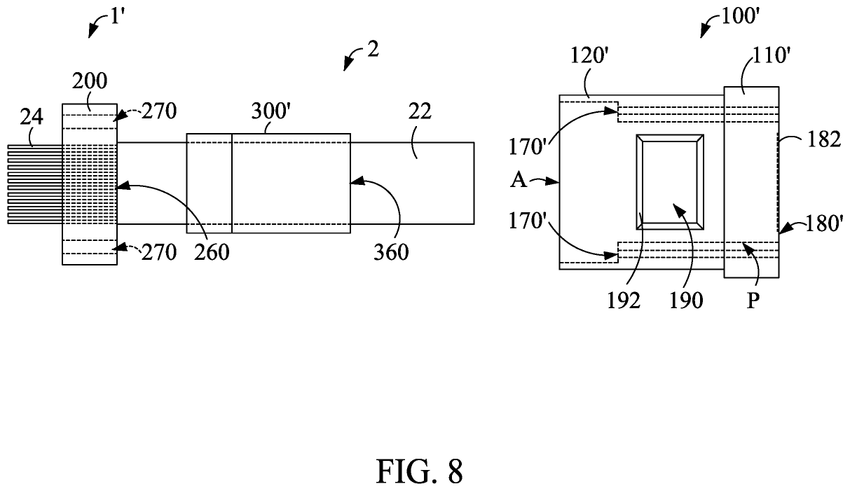

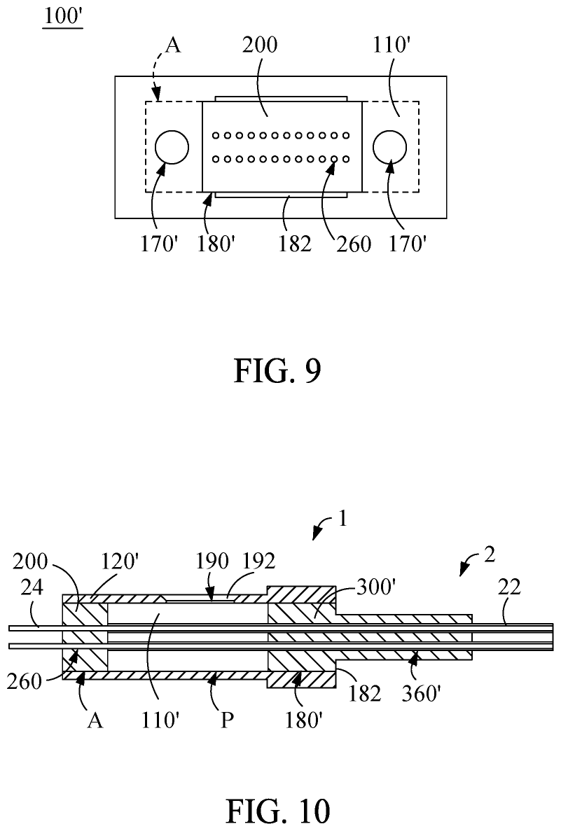

In addition, at least one of the width or height of the accommodating slot A is greater than the corresponding widths or heights of the opening 180′ and the passage P. As shown in FIGS. 8 and 9, the width of the accommodating slot A is greater than the widths of the opening 180′ and the passage P.

As shown in FIG. 8 to FIG. 10, in some embodiments, the casing 100′ may be further formed with at least one casing guiding hole 170′. The casing guiding hole 170′ penetrates the rear end portion 110′ and communicates with the accommodating slot A. When the main body 200 is disposed into the accommodating slot A, the casing guiding hole 170′ is aligned with the main body guiding hole 270.

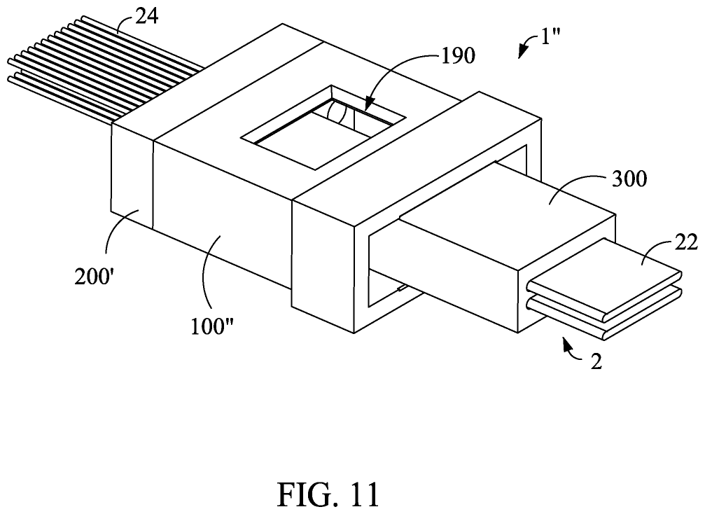

Refer to FIG. 11, the ferrule 1″ in the embodiment is essentially similar to the ferrule 1 and the ferrule 1′. The major difference between them is that the main body 200′ of the ferrule 1″ is fixed to an end of the casing 100″ and outside the casing 100″.

Specifically, the casing 100″ and the main body 200′ can also be joined through adhesive bonding or engaging. In this embodiment, the casing 100″ may be similar to the casing 100 shown in FIG. 1 as including a plurality of side walls 122. These side walls 122 surround a cavity C. However, unlike the ferrule 1, the main body 200′ is disposed outside the cavity C and fixed to a first side wall 122a with casing through-holes 160 through an adhesive such as AB glue. In this case, the width and height of the main body 200′ are preferably designed to make the main body 200′ flush with the front end portion 120. The overall appearance and smoothness are thus improved.

Alternatively, the casing 100″ can be simply formed with a passage P, while the main body 200′ is fixed to an end, such as the front end portion 120, of the casing 100″ through adhesive bonding or engaging to partially block the passage P. This arrangement allows the main body through-holes 260 to communicate with the passage P, and also achieves the effect of separately forming the casing 100″ and the main body 200′ and then joining them together securely.

It is worth mentioning that the various joining methods mentioned above can be used individually or in combination without compromising the alignment accuracy of the through-holes. For example, it is possible to simultaneously engage the main body 200′ with the casing 100″ and apply adhesive bonding to obtain a stronger bond. It is not limited by the present invention.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

What is claimed is:

1. A ferrule of optical cable with multi cores, comprising:
a casing; and
at least one main body connected to the casing, wherein a plurality of main body through-holes are formed on the at least one main body;
wherein the casing and the at least one main body are separately formed and fixed to each other, a plurality of optical fibers of a fiber optical cable pass through the plurality of main body through-holes and extrude out of the casing.

2. The ferrule according to claim 1, wherein the casing is formed with a plurality of casing through-holes aligned with the plurality of main body through-holes.

3. The ferrule according to claim 2, wherein the casing comprises a plurality of side walls connected to each other, a cavity is surrounded by the plurality of side walls, the plurality of casing through-holes are formed on a first side wall of the plurality of side walls, an opening is formed on a second side wall of the plurality of side walls, the at least one main body is disposed into the cavity through the opening and abuts against the first side wall.

4. The ferrule according to claim 2, wherein the casing comprises a plurality of side walls connected to each other, a cavity is surrounded by the plurality of side walls, the plurality of casing through-holes are formed on a first side wall of the plurality of side walls, the at least one main body is disposed outside the cavity and fixed to the first side wall.

5. The ferrule according to claim 1, wherein the casing comprises:
a rear end portion formed with a passage, wherein the fiber optical cable passes through the passage; and
a front end portion connected to the rear end portion and formed with an accommodating slot, a profile and dimensions of the accommodating slot are substantially equal to the at least one main body, the passage communicates with the accommodating slot, the at least one main body is disposed in the accommodating slot and abuts against the rear end portion.

6. The ferrule according to claim 1, wherein the casing is formed with a passage, the at least one main body is fixed to an end of the casing, the plurality of main body through-holes communicate with the passage.

7. The ferrule according to claim 1, further comprising a sheath movably disposed relative to the casing, wherein the fiber optical cable passes through the sheath.

8. The ferrule according to claim 1, wherein the casing is formed with at least one casing guiding hole, the at least one main body is formed with at least one main body guiding hole aligned with the at least one casing guiding hole.
